(19) United States
(12) Patent Application Publication
(10) Pub. No.: US 2013/0179250 A1
(43) Pub. Date: Jul. 11, 2013

(54) Digital coupon redemption

(71) Applicant: Early Bird Alert, Inc., San Rafael, CA (US)

(72) Inventors: George Nguyen, San Francisco, CA (US); Andrew Michael Kluger, San Rafael, CA (US); Stanley Ian Drew, Encino, CA (US); Miguel Alborg Dominguez, Valencia (ES); Miguel Alborg Farinos, Valencia (ES)

(73) Assignee: Early Bird Alert, Inc., San Rafael, CA (US)

(21) Appl. No.: 13/694,784

(22) Filed: Jan. 4, 2013

Related U.S. Application Data
(60) Provisional application No. 61/584,455, filed on Jan. 9, 2012.

(51) Int. Cl. G06Q 30/02

(52) U.S. Cl. CPC G06Q 30/0238
USPC 705/14.36; 705/14.38; 705/14.4

(57) ABSTRACT

A method for the simultaneous redemption and crediting of a product or service discount coupon, wherein a coupon's digital bar code is provided at the point of redemption, the digital bar code information bundled with purchase/redemption information generated at the point-of-sale, and the bundled information electronically transmitted to the coupon sponsor for instant validation and merchant compensation.

### CROSS REFERENCE TO RELATED CASES

This non-provisional patent application claims priority to provisional patent application Ser. No. 61/584,455, filed Jan. 9, 2012 entitled Digital Coupon Redemption, the content of which application is incorporated herein by reference as if fully set forth in its entirety.

### BACKGROUND OF THE INVENTION

1. Field of the Invention

This invention relates generally to a process for the management and redemption of electronic coupons. More specifically, this invention relates to a method for creating an electronic wallet for the collection of digital coupons and the redemption of said coupons at the point-of-sale. It further relates to the instantaneous redemption of said electronic coupons at the point-of-sale wherein a record of the coupon along with a proof of purchase is forwarded to the coupon issuer at virtually the same time that the discount value of the coupon is credited to the purchase transaction.

2. Description of the Related Art

Currently the redemption process in the market is highly segmented, with many fragmented systems from many entities, who are all part of a single coupon redemption lifecycle.

With print coupons (e.g. newspaper free-standing inserts, print-at-home, shelf-dispenser, etc.), redemption takes place at the retailer point-of-sale terminal. However, actual redemption is not acknowledged by the manufacturer (and/or issuer) of redeemed coupons for goods and/or services until the print coupon is sent from the retailer to the manufacturer, or to a coupon processing agent acting on behalf of the manufacturer. In the case of a coupon processing agent, all coupons received are physically scanned and the volume of coupon redemptions reported out to the respective manufacturer (and/or issuer). The manufacturer can then use the report from the coupon processing agent (or one generated internally in the case of direct receipt of redeemed coupons) to compensate the retailer for accepting/honoring the print coupons. The lag time between the moment a consumer redeems the coupon at the retailer to the point where the coupon processing agent reports back to the manufacturer can take anywhere from days to months. Even where coupon redemption is reported directly to the manufacturer, there is a significant time delay in compensating the retailer.

With digital coupons (e.g. mobile coupons that are displayed on a mobile device or sent over SMS with a key code), the redemption process still takes place at the merchant point-of-sale. However, the actual redemption is acknowledged between the manufacturer (or issuer of the coupon) and the consumer. The merchant has no transparent way to capture a coupon redemption and report back to the manufacturer (and/or issuer) for compensation. This makes it extremely difficult for manufacturers to distribute their coupons across multiple merchant chains without having to first setup each merchant chain with the exact redemption platform.

### SUMMARY OF THE INVENTION

By way of this invention a single system is provided for the distribution of coupons via print and mobile devices and also the validation of coupon authenticity with merchants and manufacturers (or issuers). The process begins with the distribution of coupons (either print and/or mobile) which contain a scannable bar code (e.g. UPC, GS1, QR Code, etc.) and/or string of human-readable text that represents the collection of coupons. The consumer can then digitally collect these coupons in a personal digital file, the file maintained by a third party provider. In one embodiment, the services of the third party provider (also hereinafter referred to as a digital coupon service provider (DCSP)) can be made available to the consumer on a membership (i.e. subscriber) basis, the third party provider storing the coupons and other data relating to the subscriber in a database maintained as part of a server system. The stored coupons are then available for redemption by the subscriber at the merchant point-of-sale.

In one embodiment, when a consumer checks out at a merchant's point-of-sale terminal, software within the terminal or located at a terminal server communicates via an electronic network to the consumer subscriber's digital coupon service provider (DCSP), and queries the service provider to investigate the account file of the consumer subscriber. When the consumer subscriber account file is located, appropriately programmed software directs the terminal to forward a digital file corresponding to the register receipt to the DCSP, where software maintained by the DCSP causes a search of a subfile of the subscriber's file for active coupons stored in the subfile, looking for coupon-product or service matches. All matched digital coupons are returned to the point of sale terminal where coupon discounts are applied, and confirmation of coupon redemption electronically transmitted via the network to the coupon sponsor/manufacturer for instant reimbursement to the retailer (i.e. merchant's) account.

In another embodiment, when a merchant is presented with a paper coupon or the displayed image of a coupon bar code, for example on the screen of a digital phone, the coupon bar code can be read with a point-of-sale scanner or mobile bar code scanner application. Scanner software then connects to a back-end server database which is programmed to simultaneously authenticate the coupons and capture the point-of-sale transaction. The merchant honors the coupons presented by the consumer, while the manufacturers (and/or issuers) will recognize and honor the redemption at the merchant point-of-sale. This process reduces the lag time for honoring and compensating a collection of coupons from days and months to seconds with a single scan at the merchant point-of-sale terminal.

### BRIEF DESCRIPTION OF THE DRAWINGS

So that the above-recited features of the present invention can be understood in detail, a more particular description of the invention, briefly summarized above, may be had by reference to various embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a representative flow diagram of a coupon collection process according to an embodiment of the invention.

FIG. 2 is a more detailed diagram of a service provider's server system database according to an embodiment of the invention for supporting such a collection process, illustrating in more detail the subcategories of information maintained in a member/subscriber file, including an electronic coupon wallet file.

FIG. 3 is a flow diagram of a redemption process according to an embodiment of the invention.

FIG. 4 is a flow chart illustrating various electronically conducted process steps of a digital coupon redemption process according to an embodiment of the invention.

### DETAILED DESCRIPTION OF THE INVENTION

The following description of the invention is directed to an embodiment of the invention in which a promotional coupon is redeemed at the point-of-sale, the coupon sponsor notified of the coupon redemption along with confirmation of purchase, and the merchant accepting the coupon immediately reimbursed by the coupon sponsor.

### Coupon Creation, Selection and Storage

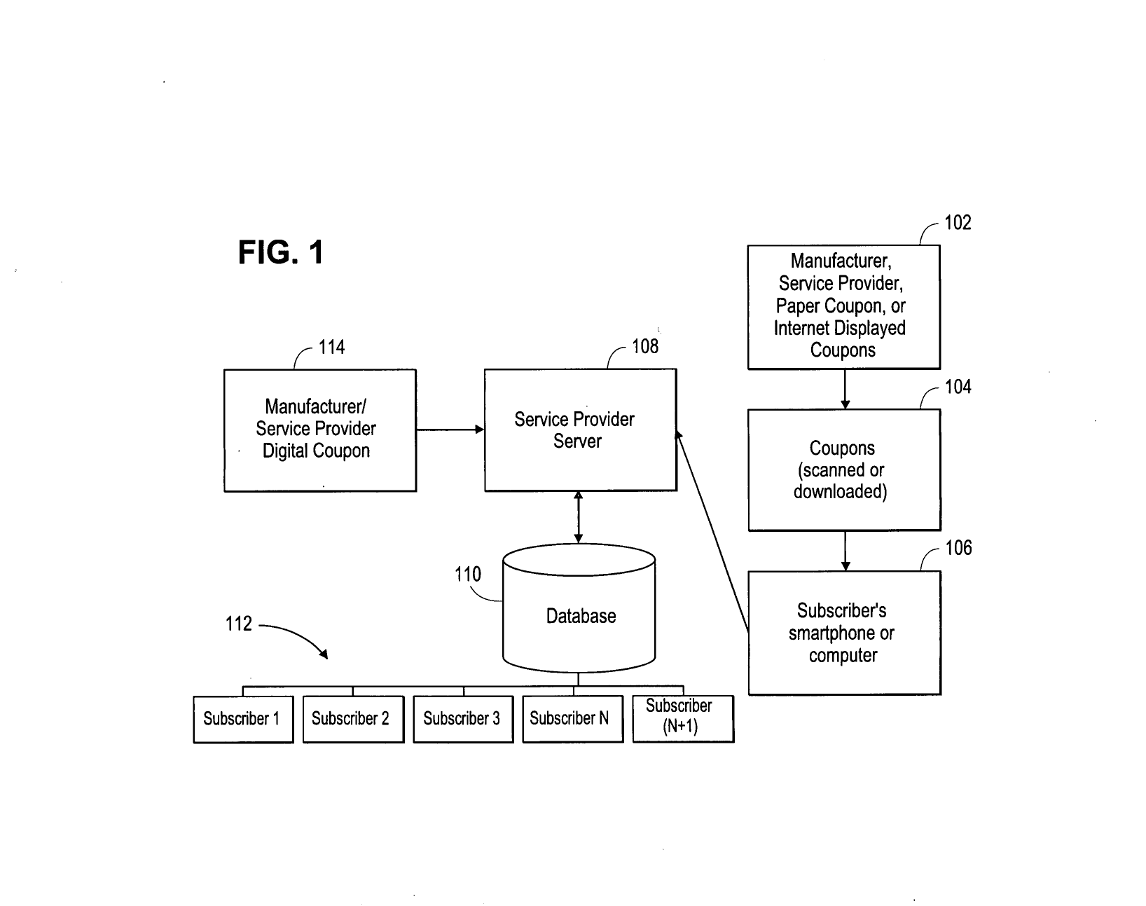

The cycle begins (FIG. 1) with issuance of a coupon, for example, by a manufacturer who wants to promote a certain product or service. This can occur in a number of ways. First, coupons can be issued in the traditional way (102) by printing and distribution via mail, newspaper, hand delivered flyers and the like. In paper form, they can also be made available in stores for presentation at check out. Also, now being implemented is the providing of a bar code as part of a printed coupon, display or billboard, such printed coupon, display or billboard offering promotional savings, the savings linked to the printed bar code, which can be scanned by a smart phone device (104) using, for example, a bar scan application, thus creating a virtual coupon which can be saved to an individual's smartphone (106). Provided the consumer is a subscriber (i.e. a member) to a network accessed service, this scanned coupon information can be sent to the digital coupon service provider (DCSP) server 108 for storage in the provider's database 110 where the subscriber's account (112) is maintained and the now digitized coupon available for later redemption. In one exemplary embodiment, the manufacturer or service provider can electronically issue a digital coupon (114) which can be sent to the Service Provider server 108 for distribution to those consumers/subscribers (112) who have signed up with a service provider to receive such digital coupons and have them placed in their digital account.

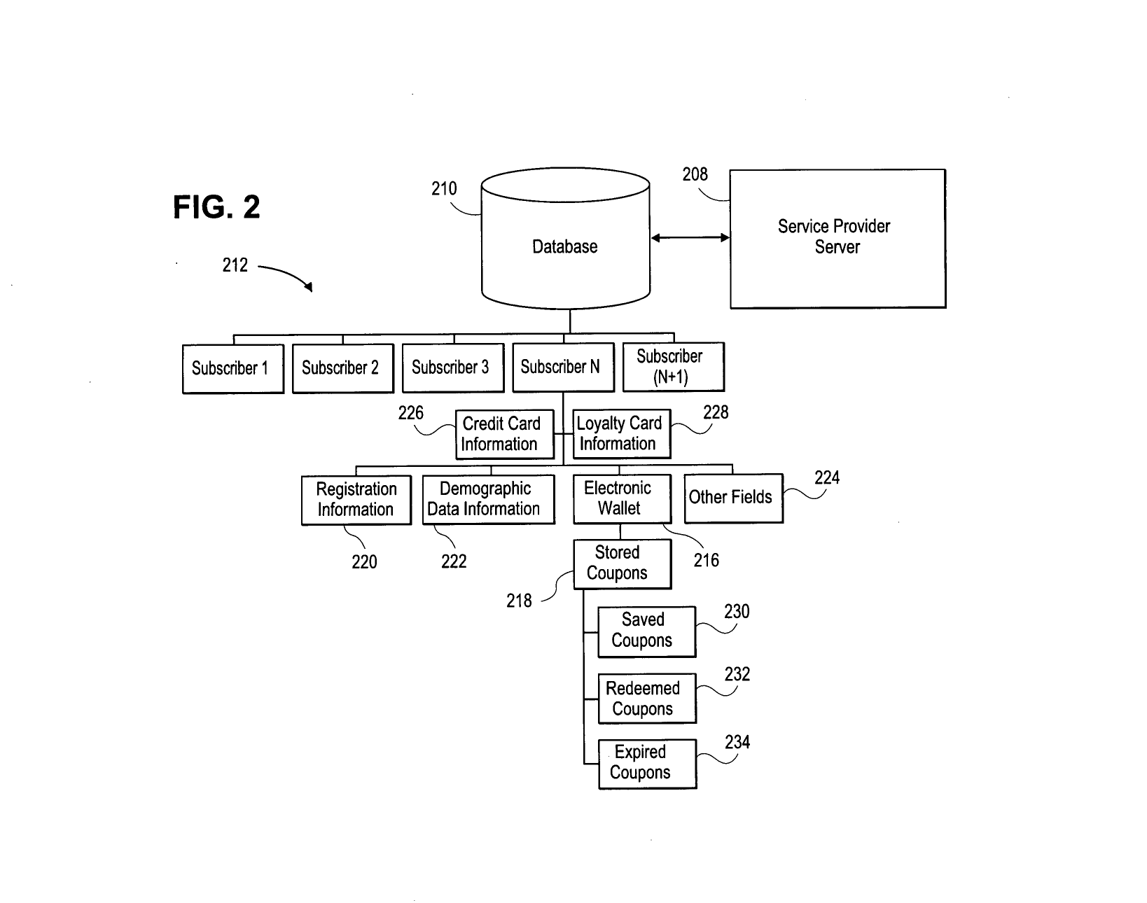

In one embodiment, as illustrated by FIG. 2, the DCSP maintains separate general folders 212 for each member/subscriber, and within each subscriber's general folder an electronic digital coupon wallet 216, also known as an electronic wallet is maintained, which digital coupon wallet file includes a coupon sub-file 218. To enter the bar code of a printed coupon into the consumer's electronic wallet, in one embodiment, scanned bar code information obtained by the user with the aid of a smart phone application (or scanner device linked to a computer) transmits the digitized bar code information to server 208 of the service provider, the digital coupon bar code information then sent to the member's digital coupon sub-file 218 of the electronic wallet 216 maintained in the subscriber's general file 212.

From their computer, the consumer subscriber can also download promotions received for example as an email sent via the internet, or to their smart phone (106 of FIG. 1), and choose to retain certain of those same coupons by selecting the ones to be saved and forwarding them to their electronic wallet 216. In another embodiment, consumers can review coupons displayed on their computer screen and select a coupon from a coupon provider linked to the DCSP network. By clicking on the coupon image, for example, the coupon can automatically be sent and saved to electronic coupon wallet 216.

Coupons can also be electronically published and sent to a distribution network by a manufacturer or service business. In one embodiment, such coupon promotions can be sent directly to one or more DCSPs (208 of FIGS. 2 and 108 of FIG. 1) for downloading into one or more of the DCSP's subscriber's digital coupon files. In one embodiment, information contained within a printed coupon bar code is digitized and made a part of the electronic coupon information file. In another embodiment the digitized bar code information can be made available in bar code readable form so the electronic coupon can be printed out or presented at a merchant terminal as a smart phone image ready for optical scanning. In one embodiment, subscribers are allowed as part of maintaining their subscription service to agree to a blanket opt-in or opt-out program where coupons may automatically be added to their electronic wallet by the DCSP, without the DCSP first obtaining permission to do so on a coupon by coupon basis.

The coupon issuer may wish to target certain consumer groups. By way of this embodiment, the coupon issuer may specify a demographic, such as age, amount of income, subscriber identified areas of interest, geographic area and the like and push the coupons only to those subscribers. In one embodiment, generalized demographic, behavioral and transactional data maintained in the subscriber' file 212 can be separately stored in a member's demographic data sub-file 222 to both limit the amount of personal information authorized by the member to be accessed by third parties, and further optimize server performance. Thus, by way of this embodiment, coupons can be automatically added to a subscriber's electronic coupon wallet without request or other input from the subscriber.

In another embodiment, the service provider can alert individual subscribers as to the availability of electronic coupons offered by a coupon sponsor such as a manufacturer, or provider of services, and allow the subscriber to opt-in to the promotion. If the subscriber chooses to opt-in, these digital promotional coupons can be downloaded from the server database 210 by server software resident in server 208 into the member's electronic wallet 216. Once stored, the digital coupon remains available in the electronic wallet for later redemption. By these methods, there is no limit to the number of digital coupons which may be stored in a subscriber's electronic wallet or the temporal currency of the wallet.

In all of these cases, be it a manufacturer, merchant retailer, or service provider, the coupon provider may place limitations and conditions on the use of the coupons, such as “limit one per customer”, “must be redeemed by a certain date”, and/or “redeemable with the purchase of a second like item”, etc. All of these conditions can be embedded as additional digitized coupon information and/or become a part of the bar code information made a part of the digital file stored in digital coupon file 218 maintained within electronic wallet 216.

In one embodiment, the services of the service provider are initially engaged in a sign-up process. A consumer/subscriber wishing to avail themselves of these services must register with the provider. In the process of registration and acceptance of terms and conditions of service, the consumer subscriber can be requested to provide certain contact information such as phone number or numbers, fax number, email address, postal address and the like. Further demographic information collected can include the member's age and sex, sex of other members of the consumer's household, income status, interests, preferences, expected near terms purchases, and the like. All of this collected information is then stored in the individual member's Registration Information file 220 maintained by the service provider. Specific demographic information can also be extracted and stored in a separate demographic data information file 222. In the case of a coupon provider who wishes to do a coupon promotion to a specific demographic group, the service provider can, with the aid of the demographic data information contained in demographic data files 222 of its subscriber database, forward incoming coupons to only those members who meet the coupon provider's specification, and who have opted in to the automatic coupon addition feature.

In another embodiment, where the subscriber/user decides to opt-in to coupon notifications from the service provider, the subscriber can receive daily or more frequent pushes of advertisements with coupons attached. These coupons can be printed, for example, at home by the subscriber on a connected printer (and redeemed in the traditional way) or the digital coupon selected by the subscriber for electronic storage in the subscriber's electronic wallet 216. Where the offering coupon (which may include an optically readable bar code) is provide by an independent third party, on the one hand, the user member can print out the offered coupons desired, and using a smart phone (for example) scan the bar code and send the scanned code to the service provider's server for storage in the s user's electronic wallet. More particularly, the scanned bar code can be captured through a mobile application on the user's smartphone or by texting the human readable information accompanying the bar code to the DCSP via SMS. Once the coupon bar code is captured, the data can be encrypted, and along with the user's device information and other personal identifiers sent to the DCSP for validation and storage in the user's digital electronic wallet 216.

In one embodiment, with the aid of his smart phone, tablet or computer the user can go to the website of the service provider and view items contained in his member file, including coupons contained in his electronic coupon wallet. The website can be designed to include a capability for the subscriber to manage his digital coupon wallet by being able to set up sub files, such by source, type of product, expiration date and the like. Also by appropriate design, the site can provide a member/subscriber with the option of being able to see both graphics and/or text of the coupons in his digital wallet, and may choose which coupons, if any, to print out.

Within a subscriber's general electronic file 212 additional sub-files can be set up such as one containing credit card information (226), one for loyalty card information (228), and “other” information (224). Within stored coupon file 218 of electronic wallet 216, such sub-files as a saved coupon file 230, a redeemed coupon file 232 and an expired coupon file 234 may also be provided.

### Coupon Redemption at Point of Sale

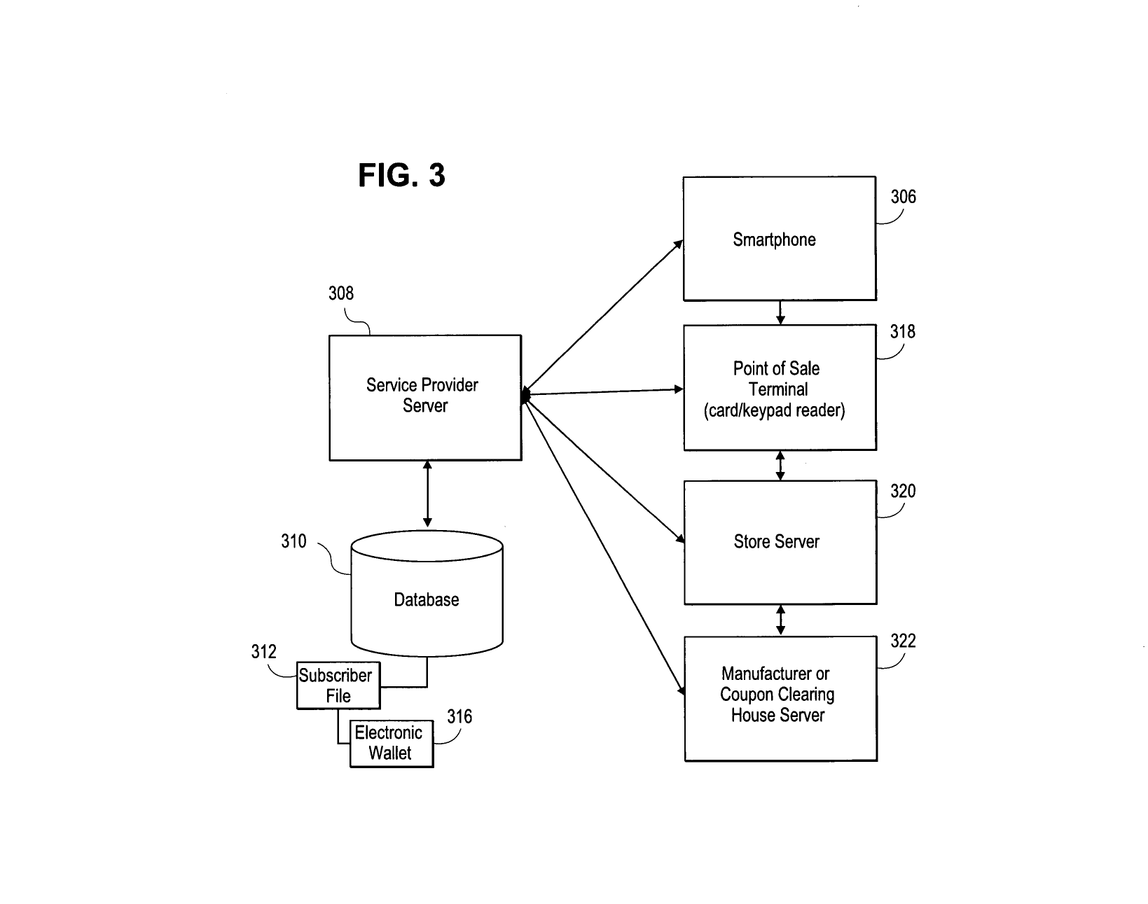

The redemption process, as exemplified by FIG. 3, starts with a shopper's presentation of one or more coupons to a merchant retailer at for example a check-out terminal. In one embodiment, the coupon can be either in printed or digital form, so long as the coupon includes a readable, that is, a scannable, bar code. The bar code may be of any form currently in market such as UPC, GS1, QR, and the like. In paper form, the coupon is read by a scanner at the check-out stand, and the discount subtracted from the check-out total.

In this first step of an exemplary redemption process, information from the scanned bar code of a paper coupon is captured by software in the retailer's point of sale terminal 318 such as an electronic register system. The scanned bar code information may include information relating to the product being purchased, the nature of the promotion (such as a certain amount off on each purchase, two for one, and the like), and the coupon sponsor. In digital format, the coupons can be accessed by the consumer subscriber's smart phone (306) and displayed on the screen of the smart phone for scanning by the scanner at the point of sale.

According to another embodiment of the invention, where at the point-of-sale there is a card reader and keypad, a consumer (who is also a DCSP member) can enter his unique subscriber identifier, such as a phone number, e.g. of his smart phone, and the keypad reader, (appropriately programmed) automatically connects via phone, cable or otherwise to server 308 of the DCSP, where the member's account is queried, and their electronic wallet 316 accessed. The digital coupons corresponding to a purchased item are then electronically returned to the checkout station and the coupon instantly redeemed, the stated value of the coupon immediately credited to the sale, and a message communicated to the sever of the service provider to confirm coupon redemption, and/or to the sponsor of the coupon to both confirm coupon redemption and effect an immediate credit back to the merchant retailer in the amount of the coupon credited to the transaction.

In still another embodiment, where at the point of sale the check-out terminal is provided with a wireless reader using a communications protocol such as Bluetooth, infrared, or near-field communication chip, the consumer subscriber can connect to his account maintained at the service provider and retrieve all currently active coupons in saved coupon file 218, and have them forwarded to his smart phone 306. Thereafter, the smart phone can transmit the coupon data to the check-out terminal for matching as in the previous case. Where there is a match, a credit is applied, and a message sent back through phone, cable, etc. to the terminal of the service provider to confirm coupon redemption.

It is to be appreciated these steps are automatically carried out by software resident within the server system (308) of the service provider, and software supporting at the check-out scanner terminal at the point-of-sale. The software code used to accomplish these actions does not itself constitute a part of this invention, and the writing of the necessary code is within the skill of the art.

As part of the process, in another embodiment, the key pad at the merchant's terminal can be connected to a merchant's store server (320). In this embodiment, the store server via the network connects to the server of the service provider and communicates the transaction to the service provider's server. Metadata generated as part of and associated with the communication (including the store location, time of the transaction, phone number of the member/customer, etc.) is combined with and sent as part of the transmitted digital coupon redemption file containing the digital receipt from the check-out terminal. In this embodiment, the combined file is received and processed by software maintained at the server of the service provider, where such resident software locates the subscriber file 312 within server database 310, and directs the incoming coupon redemption file to subscriber file 312. Additional software resident in the system queries electronic wallet 316 of the customer subscriber file looking for coupon/purchase matches.

The system looks for all coupon matches in the subscriber file of the server database and creates a sub-file containing all matches. This sub-file of matched coupons is then sent back to the merchant server in the one case for forwarding to the check-out terminal, or directly to the check-out terminal in another case (depending upon the merchant set up) where coupon credits are applied.

In a next step, the digital electronic coupon information is linked with check-out register information providing an electronic proof-of-purchase. When the transaction is complete, for each coupon and related purchase, an electronic message is sent (for example via the internet) directly to the coupon sponsor, and in one embodiment to the coupon sponsor via a coupon clearing house server (322), both informing of the transaction and authenticating it.

### Redemption of Cash Credits at the Point of Sale

At the time the coupon credit is being applied at the terminal register, an electronic message, in one embodiment, is forwarded to the coupon sponsor of the credited coupon, along with the relevant portion of the store's digital receipt. By way of a grocery store example, the consumer subscriber's purchases could include 3 coupons for 3 different Kellogg's® cereals, and 2 coupons for 4 cans of Campbell's® soup. During check out, in the match-up process at the DCSP, 3 Kellogg and 2 Campbell's Soup coupons are identified and forwarded to the point of sale terminal 318. The terminal applies the credits on final check-out and transmits a redemption notice back to the server 308 of the service provider, alerting the provider's server to delete the digital coupon from the active saved coupons file 230 of the electronic wallet 216. The deleted coupon can then be moved to the redeemed coupon file (232 of FIG. 2) for later review and marketing-related study or analysis.

Finally, at the time of transaction closeout, the merchant terminal (or its associated server) electronically communicates the fact of the sale and coupon redemption to the coupon sponsor. At the coupon sponsor's server 322, the information authenticating coupon redemption having been received, the coupon sponsor can automatically issue a cash credit to the merchant retailer in the amount of the value of the coupon, wherein said cash credit is transmitted back to the retailer and the cash credit instantly applied to the retailer's account.

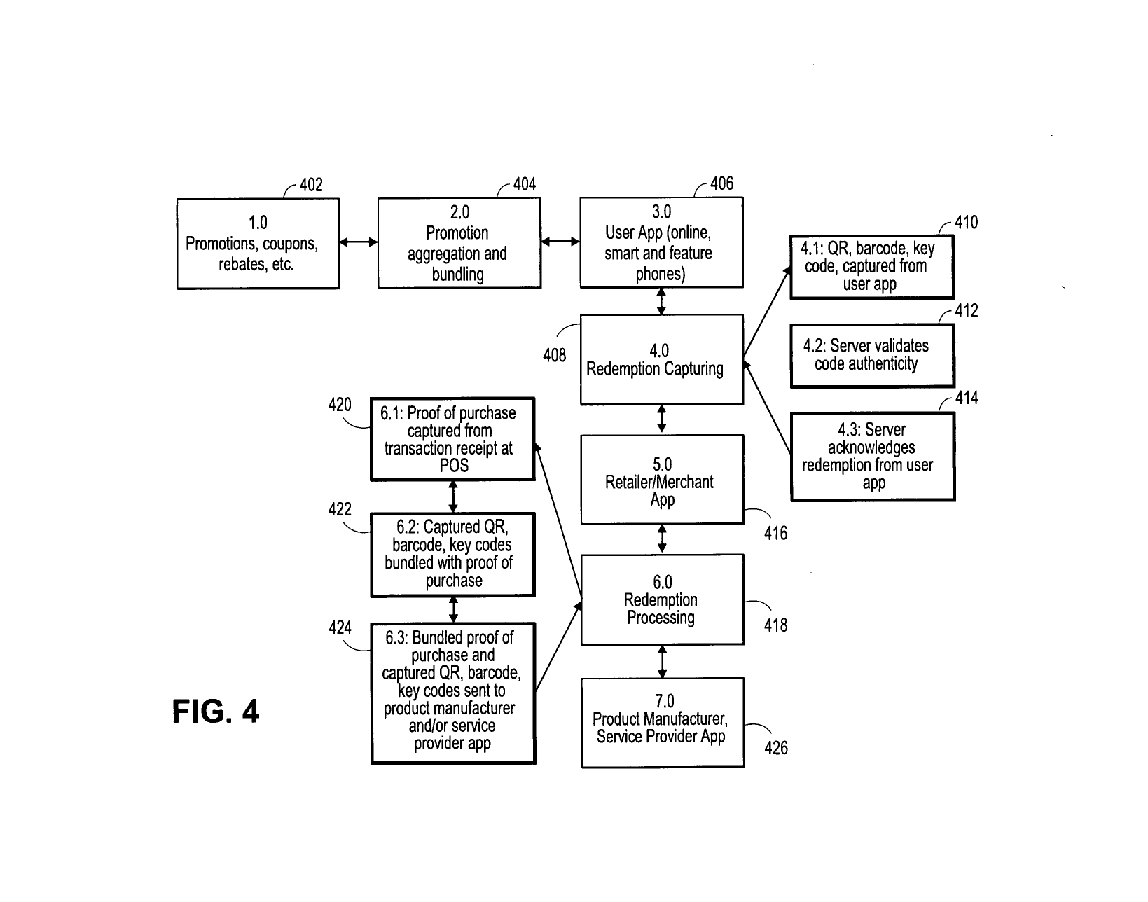

Supporting software resident in the retailer's scanner systems for reading and processing the scanned information electronically bundles captured purchase information generated during the purchase process at terminal 318, which information is then automatically transmitted to the coupon sponsor's server site. A more detailed discussion of the software managed process is described below with reference to FIG. 4. It is to be understood that the actual software code and/or algorithms employed do not constitute a part of this invention, and the writing of the necessary software code itself is within the skill of the art.

In step 1.0 (402), presentation of promotions, coupons, rebates, etc., the user is presented with a single or combination of promotions that provides a discount off of retail services and/or goods. In one embodiment where the coupons are generated by a single sponsor and issued digitally to subscribers of the coupon service, authentication of the coupon is further facilitated due to the fact that the coupon sponsor can link coupon redemption to the subscriber to whom the coupon is issued.

In step 2.0 (404) promotion aggregation and bundling, all promotions can be aggregated into a single bar code (e.g. UPC, GS1, QR Code, etc.) and/or string of human-readable text to be delivered to a user.

Next, in step 3.0 with the aid of a User Application (406), the bar code and/or human-readable text is delivered to a user via SMS text, email, and/or within a mobile/desktop application (which can also be printable).

The next step is redemption capturing (408). Here, the user presents the bar code to a retailer at the point-of-sale scanner. The bar code in step 4.1 is captured from a user's digital application or from a printed coupon by a scanner (410). The server in step 4.2 then validates bar code authenticity (412), and finally, in step 4.3 the server acknowledges redemption from the user application or print (414). In step 5.0 (416) the retailer/merchant application acknowledges the redemption and honors the discount.

In step 6.0, redemption processing (418), the server of the retailer prepares the coupon for transmission to the coupon sponsor/manufacturer/issuer. In step 6.1 (420), the proof of purchase is captured from the transaction receipt at the point of sale, and in step 6.2 (422) the captured bar code is bundled with the proof of purchase. Thereafter, in step 6.3 (424), the bundled proof of purchase and bar code package is sent (most commonly via the internet) to the manufacturer's site server.

In step 7.0 (426), the bundled package is received at the coupon sponsor/manufacturer's server site, coupon redemption acknowledged, and the retailer compensated for processing the consumer redemption.

### Analysis of Coupon Redemptions

In an embodiment of the invention, the entire coupon redemption process can be carried out by a third party intermediary such as a coupon clearing house, or a Digital Coupon Service Provider (DCSP) with the scanner/terminal at the point of sale completing the transaction through the clearing house or DCSP, and receiving the instant credit to its own cash account, the clearing house or DCSP at the same time debiting the account of the coupon sponsor. In another embodiment, the scanner/terminal at the point of sale can electronically contact the DCSP looking for coupon matches of the customer/member of the DCSP, then crediting the customer/member at check-out, while directly electronically communicating to the coupon provider, and in turn electronically obtaining redemption credits at the time of sale. In still another embodiment, the scanner/terminal at the point of sale may electronically communicate with the smart phone of the customer/member looking for a match of coupons with items purchased. Regardless of the approach followed, the net result of the transaction will be the removal of the redeemed digital coupon from the electronic wallet of the consumer/subscriber, and a notification to the coupon sponsor that the coupon has been redeemed.

One advantage of linking the DCSP to the transaction is that additional marketing data can be derived from the information stored in its database due to the membership model of the service. As previously noted, for a consumer to take advantage of the digital coupon wallet, they have to sign up and become a member/subscriber of the DCSP. In so doing, information can be obtained from that consumer such as age, sex, income, number of people in the household, income level and the like. In addition such information as travel preferences, product preferences, hobbies, activities, etc. may be collected. Where the DCSP provides other informational services, such as health and wellness related information, and the like, yet additional personal preference data may be obtained.

Coupon issuers may take advantage of the collected information maintained by the DCSP by requesting reports as to the demographics of members who redeemed their issued coupons. In this way, coupon issuers can determine not only where and when coupons have been redeemed, but something about those who used the coupons for product purchases. Thus, they are provided with a tool for better understanding the impact of their marketing drives and messages, and whether or not they are effectively reaching their target audience.

### Merchant Requirements for DCSP System Use

Large merchants with sophisticated scanners/registers/card stations who wish to use the services of a DCSP may themselves directly sign up for such service, whereby their server systems can be linked via the Internet or phone service to a DCSP site for coupon processing. Participation does not require much more than the loading of relatively small software program packages to their server systems.

Protocols for small merchants can be modified from those described above where they lack sufficient IT infrastructure. For such smaller merchants the mechanism for communication can be via software applications that reside on a merchant's smart phone, computer or computer tablet, and/or tied into the merchant's current POS software applications.

A special feature of the processes of this invention is the capability of homogenization. That is, it possible to collect coupons from all sources and mediums and deposit them into a single digital coupon electronic wallet. In one embodiment, online digital coupons can be downloaded to a member's account. As previously noted, this can be done by the user who may scan a coupon displayed on a computer screen, input human readable code into a DCSP provided software application, or text human readable code to a DCSP network. In another embodiment a bar code application of a smart phone can be used to scan the bar code of a paper coupon or an otherwise displayed bar code, and the scanned bar code downloaded to the member's electronic wallet. The required software can be provided by a DCSP as an application feature. At the DCSP server, the data file for the scanned bar code is received, and processed by software resident in the server system. Using metadata associated with the from the registered user's smart phone transmission, the data set can be specifically directed to the digital file to the member's digital coupon file maintained in their electronic wallet. Alternatively, a subscriber/user, using a keyboard or voice recognition software resident with the user's smartphone, can input the printed numbers of the bar code and these numbers forwarded to the DCSP server.

As a security feature of the digital storage and redemption embodiments of this invention, when a subscriber seeks to input a like coupon (e.g. one per customer), one where they have already used the same type of coupon, as part of the download process, software within the server can be programmed to first query Redeemed Coupon File 232, and if a match exits reject the attempt to add the new coupon. The same program can also query the active coupon file as part of the download process, and if it determines the same coupon has already been downloaded, it will reject the attempt to download a second coupon. Similarly, if the expiration date of the coupon has passed, in the download process the server can be programmed to check the coupon expiration date, and if the date of the attempted download is after the expiration date, reject the attempt to add the coupon to the saved coupons file.

In the embodiments described above, it is preferred that the digital coupon electronic wallet be stored at the server of the digital coupon service provider. In this mode, updates can be more easily managed, expired coupons removed from the active folder of the electronic wallet, redeemed coupons stored, as well as security improved as described above. Yet, it is to be appreciated that the system can be configured so that the stored coupon file of the electronic wallet can be sent to and downloaded to a subscriber's smart phone, and the capability retained to individually display graphic images of each coupon so that they may be scanned at the point of sale. Alternatively the entire electronic wallet file, once downloaded to the subscriber's smart phone, could be transmitted electronically such as by Bluetooth or other standard short distance transmission protocol to the retail terminal, and software resident within the terminal (or within a server connected to the terminal) programmed to find purchased product-coupon matches, and then preform the appropriate above described redemptions.

While the foregoing is directed to various embodiments of the present invention, other and further embodiments of the invention may be devised without departing from the basic scope thereof, which scope is limited solely by the claims that follow.

What we claim is:

1. A method for electronically processing digital electronic coupons in the course of a commercial transaction comprising the steps of:
electronically receiving at a point of sale terminal digital coupon information;
combining said digital coupon information with digitized purchase transaction information generated at the point of sale terminal, and,
transmitting said combined digital coupon information and purchase information to a server system.

2. The method of claim 1 wherein the digital coupon information includes digital bar code information.

3. The method of claim 1 wherein the combined digital coupon information and point of sale information is communicated in the form of a redemption file to a server system maintained by a coupon sponsor.

4. The method of claim 3 wherein the combined information is processed by said coupon sponsor, and thereafter a credit transmitted back to a merchant terminal linked to the point of sale wherein the discount value of the coupon is credited to the purchase transaction.

5. The method of claim 4 wherein the discount value of the coupon is credited to a merchant account for the point of sale.

6. The method of claim 1 where the digital coupon information received at the point of sale is obtained from an electronic wallet of a customer subscriber.

7. The method of claim 1 wherein the digital coupon information presented at the point of sale is contained within the memory of a smart phone of a customer subscriber and electronically communicated to the point of sale terminal via Bluetooth or other short range wireless protocol.

8. The method of claim 7 wherein at the request of the customer subscriber, one or more digital promotional coupons stored within the digital wallet of the subscriber is transmitted to the subscriber's smart phone.

9. The method of claim 2 wherein the digital coupon information includes digital bar code information which is presented at the point of sale by a smart phone of a customer subscriber as a digital bar code image capable of being scanned at the point of sale terminal by a bar code reader.

10. A method for electronically processing of coupons including a printed bar code comprising the steps of:
optically scanning the bar code of said coupon;
digitizing information generated in the process of scanning said bar code;
combining said digitized bar code information with digitized purchase information generated at a point of sale, and,
transmitting said combined digitized bar code information and purchase information to a server of a coupon sponsor.

11. A method for electronically storing digitized coupon promotions, the method comprising the steps of
digitizing a coupon bar code,
transmitting the digitized bar code information to a central server,
based on transmission metadata, including the ID of the transmitter of the digitized bar code, locating the general digital file of a subscriber associated with said metadata, and storing said digitally transmitted file in a subfile within the subscriber's general file, where stored digital coupons are maintained in a separate subfile.

12. The method of claim 11 wherein the subfile is a digital coupon wallet subfile.

13. The method of claim 12 wherein the digital coupon wallet file contains additional sub-files where saved, redeemed, and expired digital coupons are stored.

14. A method for redeeming digital coupons at a merchant point of sale terminal from a digital coupon wallet file of a data base subscriber, said method including the steps of:
receiving at a central server an electronic redemption file generated at a point of sale terminal, said electronic redemption file including a unique subscriber identifier which is linked to a subscriber general file maintained within a data base associated with said central server, said transmitted electronic redemption file including an electronic copy of a digital terminal receipt, a unique merchant identifier, and metadata comprising such information as time, and place of transaction,
searching the server database to locate the subscriber general file having said unique subscriber identifier;
accessing the subscriber general file, and thereafter accessing a digital coupon wallet file, a sub file of the subscriber general file,
comparing individual items of the digital terminal receipt to digital coupons maintained within the digital coupon wallet file and indentifying matches, resident software in said server system used to carry out the matching process;
incorporating into the redemption file one or more matched coupons: and,
electronically sending to the point of sale terminal the electronic redemption file including digital copies of the matched coupons.

15. The method of claim 14 wherein upon receipt of the returned digital coupon redemption file containing coupons with items of the digital terminal receipt, the value of each matched coupon is applied to the matched purchased item.

16. The method of claim 15, wherein at the point-of-sale, a digital file is created for each redeemed coupon, and the digital coupon along with the relevant portion of the register receipt is forwarded to the coupon sponsor or coupon clearing house for posting and credit back to the account of the point of sale merchant, the credit equal to the amount of the discount applied at the point-of-sale.

17. A method for electronically managing the processing of promotional coupons maintained in electronic form in a database of a server system for subsequent coupon redemption comprising:
providing a server system including a supporting server database;
providing separate general files within said supporting server database, each of said general files assigned to individual subscribers of the provider of the server system;
establishing separate sub files associated with each subscriber general file, said sub files including a sub file containing member registration information, and a digital electronic wallet subfile containing digital promotional coupon information, wherein said digital electronic wallet subfile further includes sub files for saved coupon, redeemed coupon and expired coupon information;
receiving by the server system an electronic transmission containing digitized coupon information; and,
storing said digital coupon information in a saved coupon subfile of the electronic wallet sub file associated with a subscriber's general file.

18. The method of claim 17 wherein the received electronic message containing the promotional electronic coupon is generated by a coupon sponsor.

19. The method of claim 17 wherein the received electronic message containing digitized coupon information is automatically distributed to subscriber general files maintained in the supporting database of the server system.

20. The method of claim 19 wherein the received electronic coupon information is automatically distributed only to those subscribers who have agreed in advance to accept promotional coupon downloads to their digital electronic wallet.

21. The method of claim 17 wherein the received electronic message containing the promotional electronic coupon is generated by a subscriber.

22. The method of claim 17 wherein during the process of storing the received digital coupon information, the server system first interrogates a subscriber's redeemed coupon file before downloading the received electronic promotional coupon to the subscriber's saved coupon file.

23. The method of claim 17 further including the step of redeeming a digital coupon whereby upon a subscriber presentation of a digital coupon at a point of sale terminal, a redemption notice generated at the point of sale terminal is transmitted back to the server system.

24. The method of claim 23, wherein upon receipt of the transmitted redemption notice, the relevant subscriber saved coupon file is accessed, and the digital coupon information associated with the redeemed coupon is moved from a save coupon subfile to a redeemed coupon subfile.

25. The method of claim 17 further including the step of receiving at the server system an inquiry from a point of sale terminal, whereby the inquiry is electronically directed to the saved coupon file of a subscriber, and a search automatically made of the saved coupon file of the subscriber to identify matches with to be purchased items contained within a digital receipt file forwarded along with the inquiry to the server system.

26. The method of claim 25 including the further steps of:
indentifying one or more matches between a purchased item and a coupon contained with the saved coupon file;
electronically communicating via the server system to the point of sale terminal digital electronic coupon information of those coupons for which a match was identified;
electronically moving the electronic coupon information of an identified electronic coupon from the member subscriber's stored coupon subfile to the member subscriber's redeemed coupon sub-file.

27. The method of claim 17 wherein the digitized coupon information includes digitized bar code information.
